(19) United States
(12) Patent Application Publication
(10) Pub. No.: US 2002/0123283 A1
(43) Pub. Date: Sep. 5, 2002

(54) Foam materials derived from high internal phase emulsions for clothing insulation

(75) Inventors: John Collins Dyer, Cincinnati, OH (US); Thomas Allen DesMarais, Cincinnati, OH (US); Bryn Hird, Cincinnati, OH (US)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 09/992,628

(22) Filed: Nov. 6, 2001

Related U.S. Application Data
(60) Provisional application No. 60/246,377, filed on Nov. 7, 2000.

(51) Int. Cl. A41H 1/00; B32B 3/00; B65B 11/00; D03D 15/00; D03D 25/00

(52) U.S. Cl. 442/181; 156/70

(57) ABSTRACT

The present invention relates to polymeric foam materials useful as insulation in clothing articles. These polymeric foams are prepared by polymerization of certain water-in-oil emulsions having a relatively high ratio of water phase to oil phase, commonly known in the art as “HIPEs.” As used herein, polymeric foam materials which result from the polymerization of such emulsions are referred to hereafter as “HIPE foams.” These HPE foams comprise a generally hydrophobic, flexible or semi-flexible, nonionic polymeric foam structure of interconnected open-cells. The HIPE foams of the present invention have:

(a) a specific surface area per foam volume of at least about 0.01 m²/cc;

(b) a density of less than about 0.0625 g/cc; and

(c) a glass transition temperature (Tg) between about −40° C. and about 90° C.

### CROSS REFERENCE TO A RELATED PATENT

This application claims priority to co-pending and commonly-owned, U.S. Provisional Application Serial No. 60/246,377, Case 8320P, titled, “Foam Materials Derived from High Internal Phase Emulsions for Clothing Insulation”; filed Nov. 7, 2000, in the name of John C. Dyer et al.

### FIELD OF THE INVENTION

This application relates to the use of microporous, open-celled polymeric foam materials suitable for insulating clothing articles.

### BACKGROUND OF THE INVENTION

The development of efficient and effective insulating materials has been the subject of substantial commercial interest. This is particularly true for materials which provide thermal insulation in clothing articles. The term “clothing” as used herein includes articles such as coats, jackets, shoes, boots, and other footwear, scarves, hats, masks, sweaters, blankets, comforters, sleeping bags, duvets, outerwear, underwear, protective suits, gloves, mittens, athletic wear, and generally any construct intended for covering and/or wearing by an individual or animal intended to provide thermal insulation to protect the user from heat or cold.

Polymeric foams derived from High Internal Phase Emulsions, termed hereinafter as “HIPE foams”, have been developed for general insulation purposes as described in U.S. Pat. No. 5,633,291 (Dyer et al.) issued May 27, 1997 and U.S. Pat. No. 5,770,634 (Dyer et al.) issued Jun. 23, 1998. HIPE foams are particularly efficient insulators owing in part to the relatively small cell size afforded by the process by which these foams are made. Among other things, U.S. Pat. Nos. 5,633,291 and 5,728,743 describe HIPE foams having a glass transition temperature between about −20° and 90° C.

Several factors are specifically important in the use of insulation in clothing. Generally, lower density insulation is preferred for cost and comfort reasons. Low density insulation facilitates the manufacture of lightweight clothing articles which typically provide greater comfort than heavier clothing with comparable insulating efficiency. The insulation should generally provide resistance to dampness and water. Animal fur and feathers, particularly down feathers, have been used traditionally as insulating components in clothing. Down feathers are particularly efficient on a weight basis when dry. However, the insulating down absorbs moisture generated by, for example, sweat, melting snow, rain, and other exposure to the elements, thereby becoming sodden, heavy, and inefficient. Substantial effort has been applied to developing synthetic fiber-based insulation for garments derived, for example, from polyester and polyester microfibers. Exemplary of such insulation are variations marketed as ThinsulateTM by 3M Co of Minneapolis, Minn. or Hollofil™ or Microloft™ fibers by DuPont Co. of Wilmington, DE or Polarguard® fibers by Lessinger Group, Inc. of Rancho Mirage, Calif. However, such insulation remains somewhat costly and is yet not as efficient as higher grades of down, while being preferred overall for damp weather applications.

Another factor is the tendency of some types of insulation to restrict the movement by the wearer. Such restriction can be caused by the bulk of the insulation or the relative stiffness of the insulating material. Restriction of movement can be particularly critical for items like gloves wherein digital dexterity is desired. In order to the provide comfortable clothing articles which facilitate unrestricted movement by the wearer, the insulating material should be soft and flexible.

Yet another factor is the ability of the insulation to avoid slumping, compacting, compressing, stress relaxation or permanent deformation after being stored in a compressed state, etc. without suffering a loss of insulating ability. Such storage may be desirable, for example, to minimize storage volume for long periods of time.

Breathability is another desirable feature of the insulating material. Permeability to vapor and breathability while repelling water and other aqueous liquids prevents the build up of sweat inside the garment or insulated article.

Additional factors include: the ease of manufacture of garments with insulation; the cost of the insulation material itself; and the ability of the clothing to be laundered using conventional washing machines and subsequently dried without loss of insulating properties.

Accordingly, it would be desirable to be able to make an insulating material that has one or more of the following benefits: (1) has good insulating ability per unit weight; (2) can be made at a reasonable cost; (3) does not gain weight and lose insulating ability when exposed to water or moisture; (4) permits manufacture of clothing articles having a high degree of flexibility in the clothing articles; (5) has a low level of stress relaxation so the insulating material will regain its original shape and insulating ability after a period of storage in a compressed state; (6) is breathable; (7) can be readily formed into clothing articles; and (8) can be laundered by conventional means.

### SUMMARY OF THE INVENTION

The present invention relates to polymeric foam materials useful as insulation in clothing articles. These polymeric foams are prepared by polymerization of certain water-in-oil emulsions having a relatively high ratio of water phase to oil phase, commonly known in the art as “HIPEs.” As used herein, polymeric foam materials which result from the polymerization of such emulsions are referred to hereafter as “HIPE foams.” These HIPE foams comprise a generally hydrophobic, flexible or semi-flexible, nonionic polymeric foam structure of interconnected open-cells. The HIPE foams of the present invention have:

(a) a specific surface area per foam volume of at least about 0.01 m²/cc;

(b) a density of less than about 0.0625 g/cc; and

(c) a glass transition temperature (Tg) between about −40° C. and about 90° C.

The present invention provides low density, compressible insulating foams for clothing articles prepared via polymerization of a HIPE comprising a discontinuous water phase and a continuous oil phase, wherein the ratio of water-to-oil is at least about 15:1. The water phase generally contains an electrolyte and a water soluble initiator. The oil phase generally consists of substantially water-insoluble monomers which can be polymerized by free radicals, an emulsifier, and other optional ingredients defined below. The monomers are selected so as to confer the properties desired in the resulting polymeric foam (e.g. mechanical integrity sufficient for the end use), flexibility, resilience, and economy. Preferably, the glass transition temperature (Tg) of the resulting foam will be between about −40° and about 20° C. so as to confer sufficient flexibility required in clothing articles.

The invention further relates to a process for obtaining these low density, compressible foams by polymerizing a specific water-in-oil emulsion or HIPE having a relatively small amount of an oil phase and a relatively greater amount of a water phase. This process comprises the steps of:

A) forming a water-in-oil emulsion from:

(1) an oil phase comprising the selected monomers;

(2) a water phase comprising from about 0% to about 20% by weight of a water-soluble electrolyte; and

(3) a volume to weight ratio of water phase to oil phase in the range of at least about 15:1; and

B) polymerizing the monomer component in the oil phase of the water-in-oil emulsion to form a polymeric foam material having:

(1) a specific surface area per foam volume of at least about 0.025 m²/cc;

(2) an expanded dry density of less than about 0.625 g/cc; and

(3) a Tg of between about −40° and about 20° C.

The polymeric foam material can subsequently be iteratively washed and dewatered to provide a dry, hydrophobic foam. (For selected applications discussed in more detail below, the foam can be rendered hydrophilic by treatment with wetting agents.) These HIPE foams may be shaped by cutting into relatively thin sheets. These HIPE foams may also be ground or comminuted into particles of various sizes. Alternatively, the HIPE foam may be produced in a more complex shape conforming to the shape of the vessel into which the HIPE is poured and cured.

### BRIEF DESCRIPTION OF THE DRAWINGS

FIG. 1 is a photomicrograph (500× magnification) of a view of a cut section of a representative polymeric foam according to the present invention (prepared as described in Example 2) in its expanded state.

### DETAILED DESCRIPTION OF THE INVENTION

I. Compressible Insulating Polymeric Foam

A. Microstructure

HIPE foams according to the present invention are relatively open-celled. This means the individual cells of the foam are in substantially complete, unobstructed communication with adjoining cells. The cells in such substantially open-celled foam structures have intercellular openings or “windows” connecting one cell to the other within the foam structure.

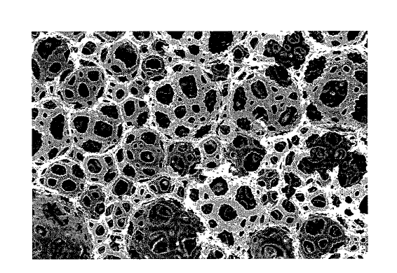

These substantially open-celled foam structures will generally have a reticulated character with the individual cells being defined by a plurality of mutually connected, three dimensionally branched webs. The individual strands of polymeric material making up these branched webs are referred to as “struts.” Open-celled foams having a typical strut-type structure are shown by way of example in FIG. 1. For purposes of the present invention, a foam material is “open-celled” if at least 80% of the cells in the foam structure that are at least 1 μm in size are in open communication with at least one adjacent cell.

HIPE foam cells will frequently be substantially spherical in shape. The size or “diameter” of such spherical cells is a commonly used parameter for characterizing foams in general. Since cells in a given sample of polymeric foam will not necessarily be of approximately the same size, an average cell size, i.e., average cell diameter, will often be specified. The method for measuring cell size is disclosed in U.S. Pat. No. 5,563,179 (Stone, et al.) issued Oct. 8, 1996.

The foams useful as insulation materials for clothing in accordance with the present invention will preferably have a number average cell size of less than about 150 μm, preferably from about 5 μm to about 130 μm, more preferably from about 10 μm to about 50 μm. Most preferably, the average cell diameters will be about 15 μm to about 35 μm for best insulating properties. Foams that are of smaller cell sizes will tend to be slower to recover to their original dimensions after application due to the interstitial residual water that applies capillary forces which resist reexpansion.

B. Form in Which the HIPE Foams are Provided

The HIPE foams of the present invention are predicable readily in large quantities with reasonable economics as either slabstock, roll stock, loose particulate, molded structures, and the like. A wide variety of shapes may be manufactured using various known techniques.

C. Surface Hydrophilicity

The HIPE foams of the present invention will be generally hydrophobic to inhibit the absorption of water or the passage of water through the foam. The internal surfaces of the foam structures are rendered hydrophobic by removal or neutralization of hydrophilizing surfactants and salts left in the foam structure after polymerization. Because the HIPE foams are open-celled, they retain breathability and vapor permeability while repelling water and other aqueous liquids. Water repellency for the purposes of the present invention is defined as having a Drop Sorption Time (DST) of greater than 30 seconds. The DST is measured by placing a drop of cold water (˜10° C.) on the surface of the HIPE foam and measuring the amount of time elapsed until the drop absorbs into the surface of the HIPE foam (i.e. the drop is no longer visibly intact to the unaided human eye from a distance of 12 inches 30 cm). A hydrophilic HIPE foam will have a DST of less than about 2 seconds. The measurement should be carried out across the width of a piece of foam so that at least 6 replicates are taken from different locations across the surface and both sides of the foam to ensure homogeneity.

D. Glass Transition Temperature (Tg)

A key parameter of the present HIPE foams is their glass transition temperature (Tg). The Tg represents the midpoint of the transition between the glassy and rubbery states of the polymer. The Tg of the HIPE foams is determined by Dynamic Mechanical Analysis (DMA) using the method described in U.S. Pat. No. 5,817,704 (Shiveley, et al.) issued Mar. 8, 1996 and incorporated herein by reference. Foams that have a Tg higher than the temperature of use can be very strong but will also be very rigid. High Tg foams typically take a long time to recover to an expanded state after having been stored in a compressed state for prolonged periods. The desired combination of mechanical properties, specifically flexibility, strength, and resilience, will necessitate selection between a range of monomer types and levels to achieve the desired end properties. In general, in applications where more freedom of movement is desired, as with mittens or sleeping bags, for example, a more flexible HIPE foam will be more useful, comprising those HIPE foams having Tgs between about −40° C. and about 20° C.

E. Foam Density

Another important property of the insulating foams of the present invention is their density. “Foam density” (i.e., in grams of foam per cubic centimeter of foam volume in air) is specified herein on a dry basis. Any suitable gravimetric procedure that will provide a determination of mass of solid foam material per unit volume of foam structure can be used to measure foam density. For example, an ASTM gravimetric procedure described more fully in the TEST METHODS section of U.S. Pat. No. 5,387,207 (Dyer, et al), issued Feb. 7, 1995, incorporated herein by reference, is one method that can be employed for density determination.

Generally, it is desirable to provide the lowest density HIPE foam possible consistent with the mechanical properties desired so as to minimize cost per unit volume while maintaining insulating efficiency. HIPE foams of the present invention have dry basis density values in the range of from about 0.010 to about 0.625 g/cc, preferably from about 0.048 to about 0.0196 g/cc, and most preferably from about 0.032 to about 0.022 g/cc.

F. Resistance to Compression Deflection

A mechanical feature of the insulating polymeric foams of the present invention is their strength in their expanded state, as determined by its resistance to compression deflection (RTCD). The method for measuring RTCD is disclosed in U.S. Pat. No. 5,563,179 (Stone, et al.) issued Oct. 8, 1996, incorporated herein by reference. The RTCD exhibited by the foams herein is a function of the polymer modulus, as well as the density and structure of the foam network. The polymer modulus is, in turn, determined by: a) the polymer composition; b) the conditions under which the foam is polymerized (e.g. the completeness of polymerization obtained, specifically with respect to crosslinking); and c) the extent to which the polymer is plasticized by residual material (e.g., emulsifiers, left in the foam structure after processing). It is desirable that the foams of the present invention be sufficiently compressible so they do not overly restrain movement in uses where free movement is required, while, at the same time, not being so compressible that they collapse and lose insulating value. Foams of the present invention will exhibit RTCD over a broad range depending on the material properties desired. Typically, this range will include 2% to 90% RTCD and will preferably between about 10% and about 50%; more preferably between about 10% and about 30%.

G. Thermal Insulation

The thermal insulating properties of a material are measured by standard test procedures well known to those skilled in the art, such as ASTM C177-85. The units in use in expressing thermal insulation efficiency vary widely and include Clo (I_{c})=0.18° C.×m²×hr/K cal, R-value=hr×ft2×° F./BTU, and k values=mW/(m×K). For comparative purposes, Down 550 fill is cited in 3M product literature as having a R-value/inch of 2.5; Type U Thinsulate™ has an R-value of 3.5. The insulation R-values/inch of foams of the present invention typically range from about 3.5 to about 5.0. Note that insulation values describe the efficiency of a volume of space and not the weight of that space. Weight (density) can be of particular importance in the insulation of clothing articles, with lower density being preferred for most applications.

H. Specific Surface Area

Another key parameter of the foams is their specific surface area, which is determined by both the dimensions of the cellular units in the foam and by the density of the polymer, and is thus a way of quantifying the total amount of solid surface provided by the foam.

Specific surface area is determined by measuring the amount of capillary uptake of a low surface tension liquid (e.g., ethanol) which occurs within a foam sample of known mass and dimensions. A detailed description of such a procedure for determining foam specific surface area via the capillary suction method is set forth in the test methods section of in U.S. Pat. No. 5,563,179 (Stone, et al.) issued Oct. 8, 1996, incorporated herein by reference. Other similar tests for determining specific surface area can be used with the present insulation foams.

I. Creep Recovery

As noted above, it is desirable that an insulating material not be permanently deformed by storage under a compressed condition. One measure of such deformation is creep recovery. It should be noted that many of the synthetic polymers used as insulating materials by the prior art are susceptible to permanent creep because they are thermoplastic. In such cases, creep recovery can be very slight. For example, a polypropylene fiber web of 1 mm thickness loaded to a pressure of 5.1 kPa at 31° C. for 4 hours recovers only slightly after the weight is removed. On the other hand, because they are highly crosslinked, the HIPE foams of the present invention provide excellent creep recovery. Suitably, the HIPE foams of the present invention when similarly loaded to a pressure of 5.1 kPa at 31° C. will recover virtually all of its original thickness within a relatively short period, depending on the Tg of the polymer comprising the HIPE foam.

II. Preparation of Polymeric Foams From HIPE Having Relatively High Water-to-Oil Ratios

A. In General

Polymeric foams according to the present invention are prepared by polymerization of HIPEs. The relative amounts of the water and oil phases used to form the HIPEs are, among many other parameters, important in determining the structural, mechanical and performance properties of the resulting polymeric foams. In particular, the ratio of water to oil in the emulsion can influence the density, cell size, and capillary suction specific surface area of the foam and dimensions of the struts that form the foam. The emulsions used to prepare the HIPE foams of the present invention will generally have a volume to weight ratio of water phase to oil phase in the range of from about 15:1 to about 100:1, more preferably from about 20:1 to about 80:1, most preferably from about 30:1 to about 65:1.

1. Oil Phase Components

The continuous oil phase of the HIPE comprises monomers that are polymerized to form the solid foam structure. This monomer component is formulated to be capable of forming a copolymer having a Tg of from about −40° to about 20° C. (The method for determining Tg by Dynamic Mechanical Analysis (DMA) is described in the TEST METHODS section of U.S. Pat. No. 5,387,207, which is incorporated by reference herein.) This monomer component includes: (a) at least one monofunctional monomer whose atactic amorphous polymer has a Tg of about 35° C. or lower (see Brandup, J.; Immergut, E. H. “Polymer Handbook”, 2nd Ed., Wiley-Interscience, New York, N.Y., 1975, III-139.); (b) at least one monofunctional comonomer to improve the toughness or tear resistance of the foam; and (c) at least one polyfunctional crosslinking agent. Selection of particular types and amounts of monofunctional monomer(s) and comonomer(s) and polyfunctional cross-linking agent(s) can be important to the realization of HIPE foams having the desired combination of structure, and thermomechanical properties which render such materials suitable for use in the invention herein.

The monomer component comprises one or more monomers that tend to impart rubber-like properties to the resulting polymeric foam structure. Such monomers can produce high molecular weight (greater than 10,000) atactic amorphous homopolymers having Tgs of about 35° C. or lower. Monomers of this type include, for example, the C₄-C₁₄ alkyl acrylates such as butyl acrylate, hexyl acrylate, octyl acrylate, 2-ethylhexyl acrylate, nonyl acrylate, decyl acrylate, dodecyl (lauryl) acrylate, isodecyl acrylate, and tetradecyl acrylate; aryl and alkaryl acrylates such as benzyl acrylate and nonylphenyl acrylate; the C₆-C₁₆ alkyl methacrylates such as hexyl methacrylate, octyl methacrylate, nonyl methacrylate, decyl methacrylate, isodecyl methacrylate, dodecyl (lauryl) methacrylate, and tetradecyl methacrylate; acrylamides such as N-octadecyl acrylamide; C₄-C₁₂ alkyl styrenes such as p-n-octylstyrene; and combinations of such monomers. Of these monomers, isodecyl acrylate, dodecyl acrylate and 2-ethylhexyl acrylate are the most preferred. The monofunctional monomer(s) will generally comprise 20 to about 45%, more preferably from about 25 to about 40%, by weight of the monomer component.

The monomer component utilized in the oil phase of the HIPEs also comprises one or more monofunctional comonomers capable of imparting toughness about equivalent to that provided by styrene to the resulting polymeric foam structure. Tougher foams exhibit the ability to deform substantially without failure. These monofunctional comonomer types can include styrene-based comonomers (e.g., styrene and ethyl styrene) or other monomer types such as methyl methacrylate (See U.S. patent application Ser. No. 60/238,990, entitled “Rapid Preparation of Foam Materials from High Internal Phase Emulsions” filed in the name of Dyer, et al. on Oct. 10, 2000, for a further discussion of the benefits of using methacrylate monomers) where the related homopolymer is well known as exemplifying toughness. The preferred monofunctional comonomer of this type is a styrene-based monomer with styrene and ethyl styrene being the most preferred monomers of this kind. The monofunctional “toughening” comonomer will normally comprise from about 10 to about 70%, preferably from about 20% to about 50%, most preferably from about 30% to about 40%, by weight of the monomer component.

In certain cases, the “toughening” comonomer can also impart the desired rubber-like properties to the resultant polymer. The C₄-C₁₂ alkyl styrenes, and in particular p-n-octylstyrene, are examples of such comonomers. For such comonomers, the amount that can be included in the monomer component will be that of the typical monomer and comonomer combined.

The monomer component also contains at least one polyfunctional crosslinking agent. As with the monofunctional monomers and comonomers, selection of the particular type and amount of crosslinking agents is very important to the eventual realization of preferred polymeric foams having the desired combination of structural and mechanical properties.

The polyfunctional crosslinking agent or agents can be selected from a wide variety of monomers containing two or more activated vinyl groups, such as divinylbenzenes and analogs thereof. Analogs of divinylbenzenes useful herein include, but are not limited to, trivinyl benzenes, divinyltoluenes, divinylxylenes, divinylnaphthalenes divinylalkylbenzenes, divinylphenanthrenes, divinylbiphenyls, divinyldiphenylmethanes, divinylbenzyls, divinylphenylethers, divinyldiphenylsulfides, divinylfurans, divinylsulfide, divinylsulfone, and mixtures thereof. Divinylbenzene is typically available as a mixture with ethyl styrene in proportions of about 55:45. These proportions can be modified so as to enrich the oil phase with one or the other component. Generally, it is advantageous to enrich the mixture with the ethyl styrene component while simultaneously reducing the amount of styrene in the monomer blend. The preferred ratio of divinylbenzene to ethyl styrene is from about 30:70 to 55:45, most preferably from about 35:65 to about 45:55. The inclusion of higher levels of ethyl styrene imparts the required toughness without increasing the Tg of the resulting copolymer to the degree that styrene does. The crosslinking agent may also be selected from the group consisting of diacrylates of diols and analogs thereof. Such crosslinking agents include those selected from polyfunctional acrylates, methacrylates, acrylamides, methacrylamides, and mixtures thereof. These include di-, tri-, and tetra-acrylates, as well as di-, tri-, and tetra-methacrylates, di-, tri-, and tetra-acrylamides, as well as di-, tri-, and tetra-methacrylamides; and mixtures of these crosslinking agents. Suitable acrylate and methacrylate crosslinking agents can be derived from diols, triols and tetraols that include 1,10-decanediol, 1,8-octanediol, 1,6-hexanediol, 1,4-butanediol, 1,3-butanediol, 1,4-but-2-enediol, ethylene glycol, diethylene glycol, trimethylolpropane, pentaerythritol, hydroquinone, catechol, resorcinol, triethylene glycol, polyethylene glycol, sorbitol and the like. (The acrylamide and methacrylamide crosslinking agents can be derived from the equivalent diamines, triamines and tetramines). The preferred diols have at least 2, more preferably at least 4, most preferably 6, carbon atoms. The cross-linking agent can generally be included in the oil phase of the HIPE in an amount of from 2% to about 45% by weight of the monomer component when calculated on the basis of the active crosslinking agent within any mixture selected (divinyl benzene being exemplary of this wherein only the percentage that is divinyl benzene would contribute to these percentages).

The major portion of the oil phase of the HIPEs will comprise the aforementioned monomers, comonomers and crosslinking agents. It is essential that these monomers, comonomers and crosslinking agents be substantially water-insoluble so that they are primarily soluble in the oil phase and not the water phase. Use of such substantially water-insoluble monomers ensures that HIPEs of appropriate characteristics and stability will be realized. It is, of course, highly preferred that the monomers, comonomers and crosslinking agents used herein be of the type such that the resulting polymeric foam is suitably non-toxic and appropriately chemically stable. These monomers, comonomers and cross-linking agents should preferably have little or no toxicity if present at very low residual concentrations during post-polymerization foam processing and/or use.

Another essential component of the oil phase of the HIPE is an emulsifier component that comprises at least a primary emulsifier. Suitable primary emulsifiers well known to those skilled in the art. Particularly preferred emulsifiers include Span 20™, Span 40™, Span 60™, and Span 80™. These are nominally esters of sorbitan based on derived from lauric, myristic, stearic, and oleic acids, respectively. Other preferred emulsifiers include the diglycerol esters derived from monooleate, monomyristate, monopalmitate, and monoisostearate acids. Mixtures of these emulsifiers are also particularly useful, as are purified versions of each, specifically sorbitan esters containing minimal isosorbide and polyol impurities.

A particularly preferred emulsifier is described in copending U.S. patent application Ser. No. 09/490,654, entitled Foam Materials and High Internal Phase Emulsions Made Using Oxidatively Stable Emulsifiers, filed in the name of Hird, et al. on Jan. 24, 2000. Such emulsifiers comprise a composition made by reacting a hydrocarbyl substituted succinic acid or anhydride or a reactive equivalent thereof with either a polyol (or blend of polyols), a polyamine (or blend of polyamines) an alkanolamine (or blend of alkanol amines), or a blend of two or more polyols, polyamines and alkanolamines. The lack of substantial carbon-carbon unsaturation rendering them substantially oxidatively stable.

In addition to these primary emulsifiers, secondary emulsifiers can be optionally included in the emulsifier component. These secondary emulsifiers can be obtained commercially or prepared using methods known in the art. The preferred secondary emulsifiers are ditallow dimethyl ammonium methyl sulfate and ditallow dimethyl ammonium methyl chloride. A particularly preferred secondary emulsifier is ditallowdimethyl ammonium methyl sulfate. When these optional secondary emulsifiers are included in the emulsifier component, it is typically at a weight ratio of primary to secondary emulsifier of from about 50:1 to about 1:4, preferably from about 30:1 to about 2:1.

As is indicated, those skilled in the art will recognize that any suitable emulsifier(s) can be used in the processes for making the foams of the present invention. For example, see U.S. Pat. No. 5,387,207 and U.S. Pat. No. 5,563,179 (Stone et al.) issued Oct. 8, 1996.

The oil phase used to form the HIPEs comprises from about 80 to about 98% by weight monomer component and from about 2 to about 20% by weight emulsifier component. Preferably, the oil phase will comprise from about 90 to about 97% by weight monomer component and from about 3 to about 10% by weight emulsifier component.

The oil phase also can contain other optional components. One such optional component is an oil soluble polymerization initiator of the general type well known to those skilled in the art, such as described in U.S. Pat. No. 5,290,820 (Bass et al), issued Mar. 1, 1994, which is incorporated by reference.

A preferred optional component is an antioxidant such as a Hindered Amine Light Stabilizer (HALS) such as bis-(,12,2,5,5-pentamethylpiperidinyl) sebacate (Tinuvin-765®) or a Hindered Phenolic Stabilizer (HPS) such as Irganox-1076® and t-butylhydroxyquinone. Another preferred optional component is a plasticizer such as dioctyl azelate, dioctyl sebacate or dioctyl adipate. Yet another optional ingredient is fillers which may toughen the polymer and/or increase its thermal insulating properties. Example fillers include aluminum, titanium dioxide, carbon black, graphite, calcium carbonate, talc, and the like. Other optional components include colorants, fluorescent agents, opacifying agents, chain transfer agents, and the like.

2. Water Phase Components

The discontinuous water internal phase of the HIPE is generally an aqueous solution containing one or more dissolved components. One essential dissolved component of the water phase is a water-soluble electrolyte. The dissolved electrolyte minimizes the tendency of monomers, comonomers, and crosslinkers that are primarily oil soluble to also dissolve in the water phase. This, in turn, is believed to minimize the extent to which polymeric material fills the cell windows at the oil/water interfaces formed by the water phase droplets during polymerization. Thus, the presence of electrolyte and the resulting ionic strength of the water phase is believed to determine whether and to what degree the resulting preferred polymeric foams can be open-celled.

Any electrolyte capable of imparting ionic strength to the water phase can be used. Preferred electrolytes are mono-, di-, or trivalent inorganic salts such as the water-soluble halides, e.g., chlorides, nitrates and sulfates of alkali metals and alkaline earth metals. Examples include sodium chloride, calcium chloride, sodium sulfate and magnesium sulfate. Calcium chloride is the most preferred for use in the present invention. Generally the electrolyte will be utilized in the water phase of the HIPEs in a concentration in the range of from about 0.2 to about 20% by weight of the water phase. More preferably, the electrolyte will comprise from about 1 to about 10% by weight of the water phase.

The HIPEs will also typically contain an effective amount of a polymerization initiator. Such an initiator component is generally added to the water phase of the HIPEs and can be any conventional water-soluble free radical initiator. These include peroxygen compounds such as sodium, potassium and ammonium persulfates, hydrogen peroxide, sodium peracetate, sodium percarbonate and the like. Conventional redox initiator systems can also be used. Such systems are formed by combining the foregoing peroxygen compounds with reducing agents such as sodium bisulfite, L-ascorbic acid or ferrous salts.

The initiator can be present at up to about 20 mole percent based on the total moles of polymerizable monomers present in the oil phase. More preferably, the initiator is present in an amount of from about 0.001 to about 10 mole percent based on the total moles of polymerizable monomers in the oil phase.

3. Other HIPE Additives

Other additives may be included by mixing in with the formed HIPE prior to polymerization. These additives may be selected from the group comprising fibers, particulates, nonwoven sheets, woven sheets, films, and other structures which are desired to be incorporated with the resulting HIPE foam. Additives which are compatible with the HIPE and which confer some reduction in the transmission of infrared light through the HIPE foam can be usefully employed. Preferred additives of this type are materials comprising carbon including particles and fibers which absorb infrared radiation and which are very compatible with the HIPE. Particularly preferred are fibers comprising carbon or graphite, the fiber form being more durably incorporated into the HIPE foam matrix than corresponding particles. Such particularly preferred fibers are described more fully in copending provisional U.S. Patent application Serial No. ______, entitled “Fiber Reinforced Foam Composites Derived From High Internal Phase Emulsions”, filed in the name of Dyer, et al. on ______ (P&G Case 8319P, Applicant will provide Serial No. when it is known), incorporated herein by reference. The absorption of infrared radiation will improve the efficiency of insulation of the HIPE foam. Also preferred are films which are highly reflective such as an aluminized polyethylene film. This can be applied to the HIPE and will generally adhere to the HIPE foam after polymerization and serve as a reflective barrier to radiant energy.

4. Hydrophilizing Surfactants and Hydratable Salts

The polymer forming the HIPE foam structure will preferably be substantially free of polar functional groups. This means the polymeric foam will be relatively hydrophobic in character. For use in clothing as defined herein above, resistance to water is generally a desired feature. Removal of the residual emulsifier and/or salt following polymerization is generally desired by simple aqueous extraction exemplified by the technique described more fully hereafter. For some applications, for example those where the HIPE foam of the insulating clothing item will be disposed in direct contact with the skin of the wearer, a hydrophilic finish may be preferred so the HIPE foam can actively absorb perspiration and wick it away from the skin of the wearer. It is noted that for occupations such as fire fighting, the combination of heavy labor, inclement hot weather, and the wearing of a protective insulating clothing item provide conditions well suited to the generation of copious amounts of perspiration which may be absorbed by the HIPE foam suitably disposed. At the conclusion of the wearing, the moisture may be squeezed out and the residual moisture removed by drying. (The HIPE foam may be part of a removable liner to facilitate this process.) Wherein it is desirable to control any malodors which may be generated in the wearing of clothing items containing the HIPE foams of the present invention, the inclusion of activated carbon fibers may be especially preferred.

B. Processing Conditions for Obtaining HIPE Foams

Foam preparation typically involves the steps of: 1) forming a stable high internal phase emulsion (HIPE); 2) optionally adding additives to the HIPE; 3) polymerizing/curing this stable emulsion under conditions suitable for forming a solid polymeric foam structure; 4) optionally washing the solid polymeric foam structure to remove the original residual water phase, emulsifier, and salts from the polymeric foam structure or to add wetting agents, and 5) thereafter dewatering this polymeric foam structure.

1. Formation of HIPE

The HIPE is formed by combining the oil and water phase components in the previously specified ratios. The oil phase will typically contain the requisite monomers, comonomers, crosslinkers, and emulsifiers, as well as optional components such as plasticizers, fillers, antioxidants, flame retardants, and chain transfer agents. The water phase will typically contain electrolytes and polymerization initiators.

The HIPE can be formed from the combined oil and water phases by some means of mixing these combined phases such as shear agitation. Shear agitation is generally applied to the extent and for a time period necessary to form a stable emulsion and to produce the water droplets of the size desired. Such a process can be conducted in either batchwise or continuous fashion and is generally carried out under conditions suitable for forming an emulsion where the water phase droplets are dispersed to such an extent that the resulting polymeric foam will have the requisite structural characteristics.

One preferred method of forming HIPE involves a continuous process that combines and emulsifies the requisite oil and water phases. In such a process, a liquid stream comprising the oil phase is formed. Concurrently, a separate liquid stream comprising the water phase is also formed. The two separate streams are then combined in a suitable mixing chamber or zone such that the requisite water to oil phase weight ratios previously specified are achieved.

In the mixing chamber or zone, the combined streams are generally subjected to shear agitation provided, for example, by a pin impeller of suitable configuration and dimensions. Shear will typically be applied to the combined oil/water phase stream at an appropriate rate. Once formed, the stable liquid HIPE can then be withdrawn from the mixing chamber or zone. This preferred method for forming HIPEs via a continuous process is described in greater detail in U.S. Pat. No. 5,149,720 (DesMarais et al), issued Sep. 22, 1992, and U.S. Pat. No. 5,827,909 (DesMarais et al) issued Oct. 27, 1998, both of which are incorporated by reference.

An alternate preferred method is described in U.S. patent application Ser. No. 09/684,037, entitled “Apparatus and Process for In-Line Preparation of HIPEs”, filed in the name of Catalfamo, et al. on Oct. 6, 2000. The method forms high internal phase emulsion (HIPE) using a single pass through the static mixer. In alternative embodiments, the HIPE may be further processed to further modify the size of dispersed phase droplets, to incorporate additional materials into the HIPE, to alter emulsion temperature, and the like.

2. Addition of Other Adjuvants

Optionally, other adjuvants compatible with the HIPE may be added before, during, or, preferably after HIPE formation but prior to polymerization to any significant degree. Such adjuvants include filler particles, dyes or pigments, flame retardants, and absorbers of infrared radiation. Since the HIPE foam of the present invention is relatively transparent to infrared (IR) radiation, thermal losses can be sustained by radiative transmission. This can be reduced by the addition of components which more effectively absorb IR frequencies. Exemplary of such adjuvants are carbon fibers, graphite fibers, and the like, as detailed in the aforementioned provisional U.S. Patent application Serial No. ______ (P&G Case 8319P). Flame retardants as disclosed in copending U.S. patent application Ser. No. 09/118,613 (Dyer) filed Jul. 17, 1998 may also be used.

3. Polymerization/Curing of the HIPE

The HIPE formed will generally be collected or poured in a suitable reaction vessel, container, trough, mold, tube, beaker, or the like, to be polymerized or cured. In one embodiment, the reaction vessel comprises a cylindrical tub constructed of polyethylene from which the eventually polymerized/cured solid foam material can be easily removed for further processing after polymerization/curing has been carried out to the extent desired. The temperature at which the HIPE is poured into the vessel is preferably approximately the same as the polymerization/curing temperature.

Suitable polymerization/curing conditions will vary depending upon the monomer and other makeup of the oil and water phases of the emulsion (especially the emulsifier systems used), and the type and amounts of polymerization initiators used. Frequently, however, suitable polymerization/curing conditions will involve maintaining the HIPE at elevated temperatures above about 30° C., more preferably above about 35° C., for a time period ranging from about 2 to about 64 hours, more preferably from about 4 to about 48 hours. The HIPE can also be cured in stages such as described in U.S. Pat. No. 5,189,070 (Brownscombe et al), issued Feb. 23, 1993. Alternatively, the HIPE may be cured at elevated temperatures and pressures as described, for example, in copending U.S. patent application Ser. No. 09/255,225 (DesMarais et al.) filed Feb. 22, 1999. The disclosure of each of which is herein incorporated by reference.

A porous water-filled open-celled HIPE foam is typically obtained after polymerization/curing in a reaction vessel, such as a tub. This polymerized HIPE foam may be cut or sliced into a sheet-like form. Sheets of polymerized HIPE foam are easier to process during subsequent treating/washing and dewatering steps, as well as to prepare the HIPE foam for use as insulating materials. The polymerized HIPE foam is typically cut/sliced to provide a cut thickness in the range of from about 0.08 to about 6.0 cm. Optionally, the HIPE may be formed into a large cylinder or billet which is subsequently ground into particles. Such grinding processes may result in a distribution of particles sizes. Preferably, at least about 80% of the particles so produced will have a diameter between about 0.1 mm and 5 mm, more preferably between about 0.5 mm and 2.0 mm. Particulate HIPE foam may also be created by suspension polymerization processes such as are described in U.S. Pat. No. 5,583,162 (LI, et al.), issued on Dec. 10, 1996. Such loose particles, when dried, are particularly useful in fill-type applications such as may be used in coats, sleeping bags, and the like.

4. Treating/Washing HIPE Foam

The polymerized HIPE foam formed will generally be filled with residual water phase material used to prepare the HIPE. This residual water phase material (generally an aqueous solution of electrolyte, residual emulsifier, and polymerization initiator) should be at least partially removed prior to further processing and use of the foam. Removal of this original water phase material will usually be carried out by compressing the foam structure to squeeze out residual liquid and/or by washing the foam structure with water or other aqueous washing solutions. Frequently several compressing and washing steps, e.g., from 2 to 4 cycles, can be used. It is preferable that the water used in these washing be heated to at least about the Tg of the polymer so as to maintain its flexibility and compliance during compressive dewatering and reduce and prevent damage to the foam structure. Optionally, the wash water may comprise about 1% sodium bicarbonate solution so as to convert any small amounts of residual calcium chloride to the nonhygroscopic calcium carbonate, thus rendering the foam substantially non-wettable.

5. Foam Dewatering

After the HIPE foam has been treated/washed, it will generally be dewatered. Dewatering can be achieved by compressing the foam to squeeze out residual water, by subjecting the foam, or the water therein to temperatures of from about 60° to about 200° C. or to microwave treatment, infrared treatment, by vacuum dewatering, or by a combination of compression and thermal drying/microwave/vacuum dewatering techniques. The dewatering step will generally be carried out until the HIPE foam is ready for use and is as dry as practicable. Frequently such compression dewatered foams will have a water (moisture) content as low as possible, from about 1% to about 15%, more preferably from about 5% to about 10%, by weight on a dry weight basis.

III. Uses of Polymeric Foams

The HIPE foams according to the present invention are broadly useful as insulating materials in clothing articles, as defined above. These foams may also provide a cushioning effect in many such constructs. Further, these foams if appropriately hydrophilized may as well provide some water imbibition properties for fluids such as sweat. In many cases, the HIPE foams of the present invention will be enclosed in a fabric unit such as, for example, a coat or a sleeping bag.

The HIPE foams of the present invention may be laminated; bonded to; or enclosed within a fabric unit (i.e., a support medium) to provide additional strength, tear resistance, or better insulating properties. For example, a thin sheet of reflective foil can be laminated on one or both sides of a HIPE foam slab so as to reduce further radiative heat transfer through the structure. The fabric unit can also be treated to provide additional benefits (e.g., hydrophobicity). The HIPE foams of the present invention may also be laminated to the inner or outer garment fabric.

The HIPE foams of the present invention may be enclosed in several ways. Nonlimiting examples include cutting a sheet-form foam into shaped panels, wherein the panel shape is defined by the specific article of clothing, and disposing the panels between two layers of fabric. The panels can then be joined to form the finished article of clothing. Alternatively, the foam can be attached to a single fabric layer and shaped as required for the ultimate use. In other embodiments, loose particles of the HIPE foam may be used to fill pockets of a predetermined size defined by the intended final use. For example, if the article is a sleeping bag, the pockets could be a plurality of relatively cylindrical tubes. One of skill in the art will recognize other ways of assembling the HIPE foams of the present invention into finished insulated articles of clothing.

Among the particular advantages of these HIPE foams over other materials used in insulating clothing are low density (weight), breathability (owing to the open-celled microstructure), water-resistance (when treated to remove any hydrophilizing residuals) or water-absorption (when treated to render hydrophilic so as to absorb, for example, sweat), a very soft tactile feel which is amenable to having the HIPE foam disposed directly against the body when desired, flexibility, durability, and whiteness.

### IV. SPECIFIC EXAMPLES

The following examples illustrate the specific preparation of collapsed HIPE foams according to the present invention.

### Example 1

### Preparation of Foam from a HIPE

A) General HIPE Preparation

Anhydrous calcium chloride (36.32 kg) and potassium persulfate (189 g) are dissolved in 378 liters of water. This provides the water phase stream to be used in a continuous process for forming the HIPE.

The monomer component is constituted as described in Table 1 (infra) and combined with a suitable emulsifier and any other adjuvants required or desired.

Separate streams of the oil phase (25° C.) and water phase (typically about 65° C.) are fed to a dynamic mixing apparatus. Thorough mixing of the combined streams in the dynamic mixing apparatus is achieved by means of a pin impeller. At this scale of operation, an appropriate pin impeller comprises a cylindrical shaft of about 21.6 cm in length with a diameter of about 1.9 cm. The shaft holds 4 rows of pins, 2 rows having 17 pins and 2 rows having 16 pins, each having a diameter of 0.5 cm extending outwardly from the central axis of the shaft to a length of 1.6 cm. The pin impeller is mounted in a cylindrical sleeve which forms the dynamic mixing apparatus, and the pins have a clearance of 0.8 mm from the walls of the cylindrical sleeve.

A spiral static mixer is mounted downstream from the dynamic mixing apparatus to provide back pressure in the dynamic mixer and to provide improved incorporation of components into the emulsion that is eventually formed. Such a static mixer is 14 inches (35.6 cm) long with a 0.5 inch (1.3 cm) outside diameter. The static mixer is a TAH Industries Model 070-821, modified by cutting off 2.4 inches (6.1 cm).

The combined mixing apparatus set-up is filled with oil phase and water phase at a ratio of 3 parts water to 1 part oil. The dynamic mixing apparatus is vented to allow air to escape while filling the apparatus completely. The flow rates during filling are 1.89 g/sec oil phase and 5.68 cc/sec water phase.

Once the apparatus set-up is filled, agitation is begun in the dynamic mixer, with the impeller turning at the rate specified in Table 1. The following procedure is illustrative although different flow rates and impeller RPMs may be utilized to derive the foam properties desired. The flow rate of the water phase is then steadily increased to a rate of 45.4 cc/sec and the oil phase flow rate is reduced to 0.82 g/sec over a time period of about 2 min. These flow rates may be adjusted further to achieve the water-to-oil (W:O) ratios shown in Table 1. The back pressure created by the dynamic and static mixers at this point is 13.4 PSI (92 kPa). The impeller speed is then steadily decreased to a speed of 1200 RPM over a period of 120 sec. The back pressure drops to 5.4 PSI (37 kPa). The flow rates of the oil and aqueous phases are adjusted to achieve the W:O ratio desired for the HIPE. The RPM of the dynamic mixer is similarly adjusted. Exemplary conditions are shown in Table 1:

TABLE 1
Exemplary Oil Phase Compositions, W:O Ratios, and RPMs.

| Ex- | STY | DVB4 | EHA | HDDA | ISO | W:O | | Tg |
|---|---|---|---|---|---|---|---|---|
| ample | Parts | 2 Parts | Parts | Parts | Parts | Ratio | RPM | (° C.)* |
| 1a | 26.3 | 16.2 | 57.5 | 0.0 | | 13:1 | 300 | 12° |
| 1b | 26.3 | 16.2 | 57.5 | 0.0 | | 35:1 | 1200 | 12° |
| 1c | 25 | 12 | 58 | 5 | | 35:1 | 1200 | |
| 1d | 25 | 12 | 0 | 5 | 58 | 35:1 | 1200 | |
| 1e | 0 | 30 | 35 | 0 | 35 | 35:1 | 1200 | 10° |
| 1f | 15 | 20 | 0 | 0 | 65 | 35:1 | 1200 | |
| 1g | 20 | 20 | 60 | 0 | 0 | 40:1 | 1200 | |
| 1h | 28 | 22 | 50 | 0 | 0 | 34:1 | 1200 | |

STY = styrene; available from Aldrich Chemical Co.
DVB = divinyl benzene, based on 42% purity with 58% ethyl styrene impurity; available from Dow Chemical Corp.
EHA = 2-ethylhexyl acrylate; available from Aldrich Chemical Co.
HDDA = 1,6-hexanediol diacrylate; available from Aldrich Chemical Co.
ISO - isoprene; available from Aldrich Chemical Co. When isoprene is employed, the HIPE is formed at a temperature of 5° C. and the HIPE is cured in a pressurized vessel at 65° C., the vessel being pre-pressurized with nitrogen or other inert gas to at least 3 atmospheres.
*Tg is determined using Dynamic Mechanical Analysis at 1.0 radians/second as described in U.S. Pat. No. 5,817,704 (Shiveley et al.) issued October 6, 1998.

B) Polymerization/Curing of HIPE

The HIPE from the static mixer is collected in a round polypropylene tub, 17 in. (43 cm) in diameter and 7.5 in. (10 cm) high, with a concentric insert made of Celcon plastic. The insert is 5 in. (12.7 cm) in diameter at its base and 4.75 in (12 cm) in diameter at its top and is 6.75 in. (17.14 cm) high. The HIPE-containing tubs are kept in a room maintained at 65° C. for 18 hours to cure and provide a polymeric HIPE foam. Alternatively, other shapes and types of receiving vessels may be employed as appropriate.

C) Foam Washing and Dewatering

The cured HIPE foam is removed from the tubs. The foam at this point has residual water phase (containing dissolved emulsifiers, electrolyte, initiator residues, and initiator) about 50-60 times (50-60×) the weight of polymerized monomers. The foam is sliced with a sharp reciprocating saw blade into sheets which are 0.2 inches (0.5 cm) in thickness. These sheets are then subjected to compression in a series of 2 porous nip rolls equipped with vacuum which gradually reduces the residual water phase content of the foam to about 6 times (6×) the weight of the polymerized monomers. At this point, the sheets are then resaturated with a water at 60° C., are squeezed in a series of 3 porous nip rolls equipped with vacuum to a water phase content of about 4×. The CaCl₂ content of the foam is less than about 1%. The washing process may also include wetting agents in cases wherein the final foam is desired to have hydrophilic properties.

### Example 2

A foam is prepared substantially as described in Example 1 with the exception that the following oil phase composition and process conditions are used:

Oil Phase Composition

Monomer Component: 96%

18% Styrene

23% Technical Divinylbenzene (˜42% divinylbenzene and ˜58% ethyl styrene)

59% 2-Ethylhexyl acrylate

Emulsifier Component: 4%

Emulsifier made according to the aforementioned copending U.S. patent application Ser. No. 09/490,654

Process Conditions

Impeller Speed: 1400 RPM

Water to Oil Ratio: 25:1

### Example 3

The procedure according to Example 1g is repeated except that prior to curing, carbon fiber obtained from Osaka Gas Chemical Ltd. (Osaka, Japan) is added to the formed HIPE at a level of 10% by weight of oil phase used and dispersed therein with sufficient mixing to achieve a homogeneous blend to the eye. The HIPE is then cured normally and processed to provide a gray HIPE foam with improved thermal insulating efficiency as compared with exemplary foams

```
Oil Phase Composition
  Monomer Component: 96%
    18% Styrene
    23% Technical Divinylbenzene (˜42% divinylbenzene and
    ˜58% ethyl styrene)
    59% 2-Ethylhexyl acrylate
  Emulsifier Component: 4%
    Emulsifier made according to the aforementioned copending
    U.S. patent application Ser. No. 09/490,654
Process Conditions
  Impeller Speed: 1400 RPM
  Water to Oil Ratio: 25:1
```

lacking the carbon fiber.

### Example 4

The foam of Example 3 is ground into particles where 90% of the particles (on a weight basis) have an equivalent diameter between 0.5 and 2.0 mm. The particles may be sieved as needed to achieve this distribution. The particles are then used to replace the down insulation in a standard down sleeping bag on an equal weight basis. The modified bag compares favorably with the original bag in terms of flexibility, comfort while sleeping, and thermal insulation. Both bags are wetted to simulate the effect of melting snow or rain. The down version picks up considerable weight and loses insulation efficiency. The particulate foam filled version does not.

### Example 5

The foam of Example 4 is used to replace the down insulation in a parka in the manner discussed in the preceding example. The foam particle insulated parka compares favorably with the original parka in terms of comfort while wearing, both flexibility and warmth. The advantages are similarly increased when the parka picks up moisture, as from sweat, melting snow, rain, or the like.

### Example 6

The foam of Example 4 is used to replace the fiber-fill of a winter coat. The modified example compares favorably with the original with respect to wearing comfort, both in terms of flexibility and warmth. The particulate foam filled jacket may be laundered and/or stored in a compressed state (or folded state) with little change in its properties.

The disclosures of all patents, patent applications (and any patents which issue thereon, as well as any corresponding published foreign patent applications), and publications mentioned throughout this description are hereby incorporated by reference herein. It is expressly not admitted, however, that any of the documents incorporated by reference herein teach or disclose the present invention.

While various embodiments and/or individual features of the present invention have been illustrated and described, it would be obvious to those skilled in the art that various other changes and modifications can be made without departing from the spirit and scope of the invention. As will be also be apparent to the skilled practitioner, all combinations of the embodiments and features taught in the foregoing disclosure are possible and can result in preferred executions of the invention. It is therefore intended to cover in the appended claims all such changes and modifications that are within the scope of this invention.

What is claimed is:

1. A method for using a polymeric foam material derived from a high internal phase emulsion for insulating clothing, the method comprising the steps of:
A) providing a high internal phase derived polymeric foam material having:
(a) a specific surface area per foam volume of at least about 0.01 m²/cc;
(b) a density of less than about 0.0625 g/cc;
(c) a glass transition temperature (Tg) between about −40° C. and about 20° C.; and
(d) a drop sorption time of at least about 30 seconds; and
B) associating said foam with a fabric unit by a method selected from the group consisting of laminating, bonding and enclosing to form said insulated clothing.

2. The method of using the foam material of claim 1 for insulating clothing, wherein said foam has a glass transition temperature (Tg) of from about −10° to about 20° C.

3. The method of using the foam material of claim 1 for insulating clothing, wherein said foam has a dry, expanded density of between about 0.048 and 0.196 g/cc.

4. The method of using the foam material of claim 1 for insulating clothing, wherein the clothing is selected from the group consisting of gloves and mittens.

5. The method of using the foam material of claim 1 for insulating clothing, wherein the clothing is selected from the group consisting of coats and jackets.

6. The method of using the foam material of claim 1 for insulating clothing, wherein the clothing comprises footwear including shoes and boots.

7. The method of using the foam material of claim 1 for insulating clothing, wherein the fabric unit has been treated to be substantially hydrophobic.

8. The method of using the foam material of claim 1 for insulating clothing, wherein the clothing comprises headwear and is selected from the group consisting of hats, scarves, and face masks

9. The method of using the foam material of claim 1 for insulating clothing, wherein the clothing comprises sleeping bags.

10. The method of using the foam material of claim 1 for insulating clothing, wherein the clothing is selected from the group consisting of blankets, comforters, and bedspreads.

11. The method of using the compressible foam material of claim 1 for insulating clothing, wherein the foam material is comminuted into particles less than about 1 cm in diameter.

12. The method of using the compressible foam material of claim 1 for insulating clothing, wherein the foam material also contains at least about 2% by weight carbon fiber.
